(19) United States
(12) Patent Application Publication
(10) Pub. No.: US 2022/0173545 A1
(43) Pub. Date: Jun. 2, 2022

(54) CONNECTOR AND CONNECTOR ASSEMBLY

(71) Applicant: Molex, LLC, Lisle, IL (US)

(72) Inventors: Atsushi ISHIKAWA, Yamato (JP); Ayako IDA, Yamato (JP)

(73) Assignee: Molex, LLC, Lisle, IL (US)

(21) Appl. No.: 17/105,640

(22) Filed: Nov. 27, 2020

(51) Int. Cl. H01R 13/506; H01R 13/426

(52) U.S. Cl. CPC H01R 13/506; H01R 13/426

(57) ABSTRACT

The present disclosure includes: a holder; and a harness housing unit coupled to the holder; wherein this harness housing unit includes multiple harness housings connected to the ends of electric wire harnesses including electric wires 91 and is configured by coupling adjacent harness housings in the width direction.

### RELATED APPLICATION

This application claims priority to Japanese Application No. 2018-014725 filed on Jan. 31, 2018, which is incorporated herein by reference in its entirety.

### TECHNICAL FIELD

The present disclosure relates to a connector and a connector assembly.

### BACKGROUND ART

Conventionally, in electric wire-to-substrate connectors for connecting electric wires such as cables to a circuit board such as a printed circuit board, the following technique is proposed, wherein electric wires of electric wire harnesses are arranged in a single row and connected to obtain a pair of harness housings, which are coupled via a holder to configure one electric wire connector, and this electric wire connector is inserted into and mated with a housing of a substrate connector (for example, see Patent Document 1). As a result, the electric wires arranged in two rows can be connected to the circuit board.

FIG. 23 is an exploded view of a conventional connector.

In the drawing, 811 is a pair of harness housings within each of which electric wires 891 of electric wire harnesses are arranged in a single row and connected, wherein the pair of harness housings are coupled via a holder 831 while mutually facing each other so as to configure an electric wire connector. Each harness housing 811 includes multiple terminal housing chambers 813, wherein terminals (not illustrated) connected to the tip of each electric wire 891 are housed in the terminal housing chambers 813.

In contrast, the holder 831 includes: a pair of end walls 832; and a partition wall 833 coupled to the end walls 832. An engaging groove 836 is formed on each end wall 832. Moreover, a guide groove 837 is formed on both surfaces of the partition wall 833. Further, a holding piece 834 is formed at the front edge 833f of the partition wall 833, with a locking piece 834a formed at the tip of this holding piece 834.

In addition, each harness housing 811 is positioned (such that the front edge 811f thereof faces the holding piece 834 of the holder 831) and attached to the holder 831 by allowing an engaging protrusion 821 protruding from the side end surface to engage with the engaging groove 836 and allowing a guide protrusion 822 protruding from the inner side wall 812 to engage with the guide groove 837. In this case, the front edge 811f is locked by the locking piece 834a formed at the tip of the holding piece 834.

In this manner, an electric wire connector configured by coupling a pair of harness housings 811 via the holder 831 is inserted into and mated with a housing of a substrate connector (not illustrated). As a result, two rows of electric wires 891 can be electrically connected to a circuit board (not illustrated) on which the substrate connector is mounted.

Prior Art Documents Patent Documents Patent Document 1 JP 2004-241315 A

### SUMMARY

Unfortunately, in conventional electric wire connectors, because the holder 831 is manufactured so as to correspond to the size of the harness housings 811, when the number of poles, that is, the number of terminals, is changed, for example, and more electric wires 891 are required to be connected, not only the harness housings 811 but also the holder 831 must be remade into one capable of connecting more electric wires 891, leading to an increase in manufacturing costs. Moreover, because only each single harness housing 811 can be coupled to both sides of the holder 831, if a large number of electric wire harnesses are connected to a circuit board, multiple electric wire connectors and substrate connectors are required to be prepared, such that not only the number of parts but also the workload for allowing the electric wire connectors to mate with the substrate connectors increases, leading to an increase in manufacturing costs.

Here, in order to solve the problems of conventional connectors, an object is to provide a connector and a connector assembly which allow multiple electric wire harnesses to be integrated into a single connector (by combining multiple harness housings to configure a unit capable of being coupled to a holder), allow for a reduction in the number of parts, allow for a reduction in the workload necessary for the mating between the connector and a counterpart connector, and allow for a reduction in manufacturing costs.

With this in mind, a connector includes: a holder; and a harness housing unit coupled to the holder; wherein this harness housing unit includes multiple harness housings connected to the ends of electric wire harnesses including electric wires and is configured by coupling adjacent harness housings in the width direction.

In another connector, each of the harness housings includes a terminal housing recess which houses terminals connected to the ends of the electric wires, wherein the holder includes an insertion part that is inserted into each of the harness housings.

Further, in yet another connector, the insertion part includes a retainer which prevents the terminals from being drawn out of the terminal housing recess.

Further, in yet another connector, the harness housing includes: a coupling rib formed on a first side part; and a coupling groove which is formed on a second side part and into which the coupling rib is capable of being inserted.

Further, in yet another connector, the harness housing includes: a projection which is formed on the first and second side parts; and a recess formed on this projection, wherein a space into which counterpart terminals are capable of entering is configured by the recess between the first and second side parts of mutually coupled adjacent harness housings.

Further, in yet another connector, the holder includes a partition wall extending in the width direction, wherein each harness housing unit is coupled to both sides of this partition wall.

Further, in yet another connector, a locking recess is formed on the partition wall, wherein a locking protrusion (which is formed in the harness housing possessed by harness housing units on both sides of the partition wall) engages with the locking recess.

Further, in yet another connector, the holder includes an end plate part connected to both ends of the partition wall, wherein a locking member (which includes the locking recess capable of engaging with the locking protrusion of a counterpart connector) is formed on the outer surface of this end plate part.

A connector assembly includes: the connector according to the present disclosure; and a counterpart connector including a mating space into which the connector is capable of being inserted.

According to the present disclosure, a connector combines multiple harness housings to configure a unit capable of being coupled to a holder. This allows multiple electric wire harnesses to be integrated into a single connector, allows for a reduction in the number of parts, allows for a reduction in the workload necessary for the mating between the connector and a counterpart connector, and allows for a reduction in manufacturing costs.

### BRIEF DESCRIPTION OF THE DRAWINGS

FIG. 1 is a perspective view of a connector assembly in Embodiment 1.

FIG. 2 is a perspective view of the connector assembly prior to mating in Embodiment 1.

FIGS. 3A and 3B are rear surface views of the connector assembly before and after mating in Embodiment 1, wherein FIG. 3A is a view illustrating the state after mating and FIG. 3B is a view illustrating the state before mating.

FIGS. 4A and 4B are cross sectional views of the connector assembly after mating in Embodiment 1, wherein FIG. 4A is a cross sectional view in the arrow direction along line A-A in FIG. 3A, while FIG. 4B is a cross sectional view in the arrow direction along line B-B in FIG. 3A.

FIG. 5 is a cross sectional view of the connector assembly before mating in Embodiment 1 and a cross sectional view in the arrow direction along line C-C in FIG. 3B.

FIG. 6 is a bottom view of the connector in Embodiment 1.

FIG. 7 is an exploded view of the connector in Embodiment 1.

FIG. 8 is a perspective view of a clip housing in Embodiment 1.

FIGS. 9A and 9B are perspective views of a harness housing unit of the connector in Embodiment 1, wherein FIG. 9A is a perspective view of a front harness housing unit, while FIG. 9B is a perspective view of a rear harness housing unit.

FIG. 10 is a partially exploded view of the harness housing unit of the connector in Embodiment 1.

FIGS. 11A and 11B are perspective views of a harness housing of the connector in Embodiment 1, wherein FIG. 11A is a perspective view of a harness housing with a small number of poles, while FIG. 11B is a perspective view of a harness housing with a large number of poles.

FIGS. 12A-12E are five-plane drawings of the harness housing with a small number of poles in Embodiment 1, wherein FIG. 12A is a front view, FIG. 12B is a top view, FIG. 12C is a bottom view, FIG. 12D is a side view, and FIG. 12E is a back view.

FIGS. 13A-13E are five-plane drawings of the harness housing with a large number of poles in Embodiment 1, wherein FIG. 13A is a front view, FIG. 13B is a top view, FIG. 13C is a bottom view, FIG. 13D is a side view, and FIG. 13E is a back view.

FIG. 14 is a perspective view of a connector assembly in Embodiment 2.

FIG. 15 is a first exploded view of the connector assembly in Embodiment 2.

FIG. 16 is a second exploded view of the connector assembly in Embodiment 2.

FIGS. 17A and 17B are two-plane drawings of the connector assembly in Embodiment 2, wherein FIG. 17A is a top view, while FIG. 17B is a cross sectional view in the arrow direction along line D-D in FIG. 17A.

FIGS. 18A and 18B are perspective views of a substrate connector in Embodiment 2, wherein FIG. 18A is a view viewed from the first angle, while FIG. 18B is a perspective view viewed from the second angle.

FIGS. 19A and 19B are perspective views of an electric wire connector in Embodiment 2, wherein FIG. 19A is a perspective view viewed from the front, while FIG. 19B is a perspective view viewed from the rear.

FIG. 20 is an exploded view of the electric wire connector in Embodiment 2.

FIGS. 21A and 21B are two-plane drawings of the electric wire connector in Embodiment 2, wherein FIG. 21A is a top view, while FIG. 21B is a cross sectional view in the arrow direction along line E-E in FIG. 21A.

FIGS. 22A-22D are four-plane drawings of a holder including a retainer member in Embodiment 2, wherein FIG. 22A is a top view, FIG. 22B is a front view, FIG. 22C is a rear view, and FIG. 22D is a side view.

FIG. 23 is an exploded view of a conventional connector.

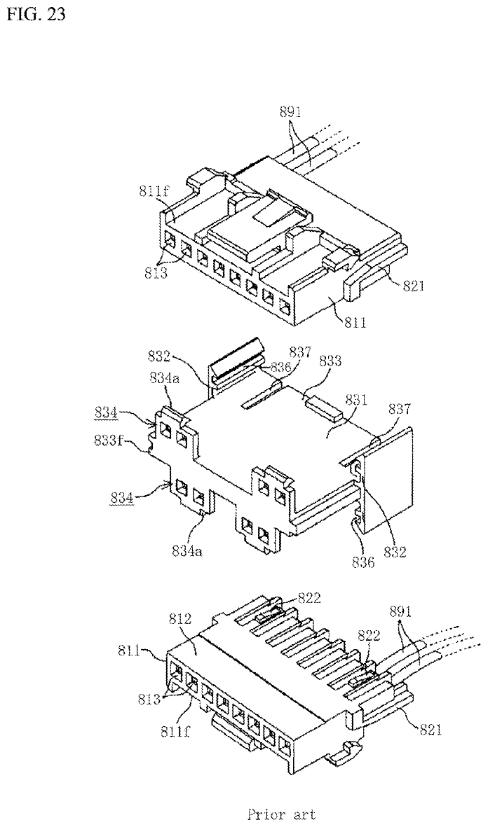

### DETAILED DESCRIPTION OF THE PREFERRED EMBODIMENT

Embodiments will hereinafter be described in detail with reference to the drawings.

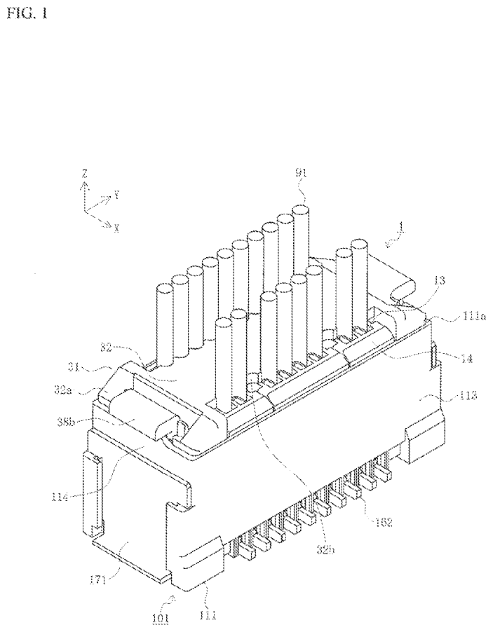

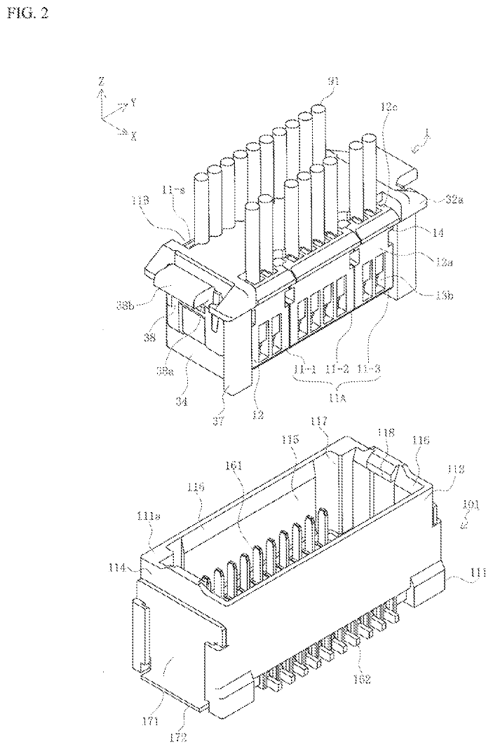

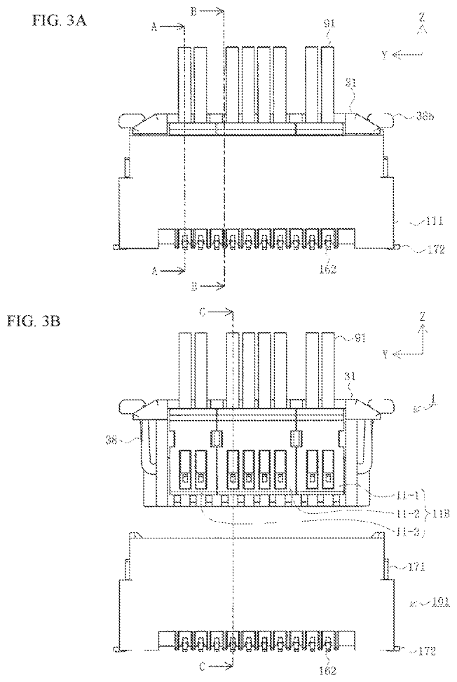

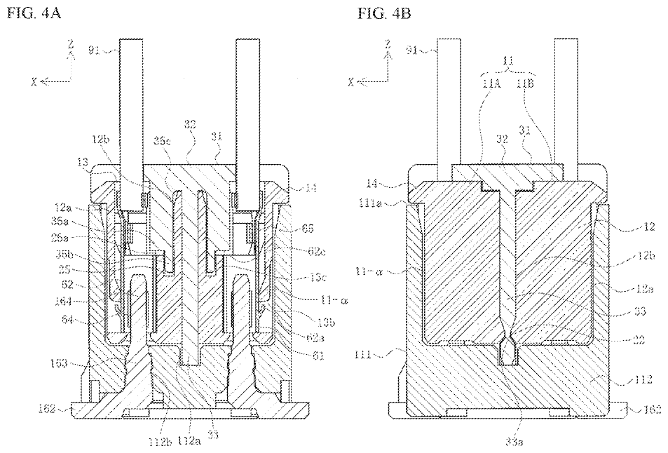

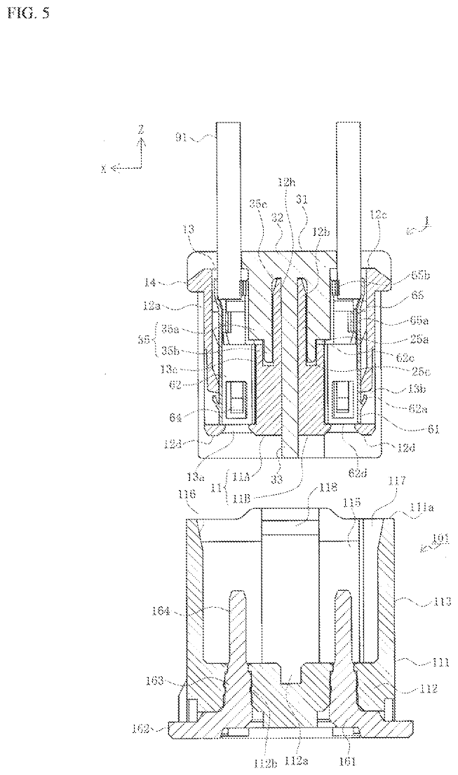

FIG. 1 is a perspective view of a connector assembly in Embodiment 1, FIG. 2 is a perspective view of the connector assembly prior to mating in Embodiment 1, FIGS. 3A and 3B are rear surface views of the connector assembly before and after mating in Embodiment 1, FIGS. 4A and 4B are cross sectional views of the connector assembly after mating in Embodiment 1, and FIG. 5 is a cross sectional view of the connector assembly before mating in Embodiment 1, and a cross sectional view in the arrow direction along line C-C in FIG. 3B. Note that, in FIGS. 3A and 3B, FIG. 3A is a view illustrating the state after mating, while FIG. 3B is a view illustrating the state before mating, and in FIGS. 4A and 4B, FIG. 4A is a cross sectional view in the arrow direction along line A-A in FIG. 3A, while FIG. 4B is a cross sectional view in the arrow direction along line B-B in FIG. 3A.

In the drawings, 1 is an electric wire connector as a connector in the present embodiment and is connected to the ends of electric wire harnesses including multiple electric wires 91. Moreover, 101 is a substrate connector as a counterpart connector in the present embodiment and is mounted on a circuit board as a substrate (not illustrated). In addition, the electric wire connector 1 and the substrate connector 101 are capable of mutually mating so as to configure a connector assembly in the present embodiment. Note that the substrate connector 101 is a so-called straight type connector and mounted while erected toward the circuit board, that is, while opened upward. In addition, the electric wire connector 1 is vertically mated with the substrate connector 101, consequently allowing the electric wires 91 to be vertically pulled out to the circuit board.

Moreover, expressions for indicating directions such as up, down, left, right, front, and back, used to describe the operations and configurations of the parts of the electric wire connector 1 and the substrate connector 101 in the present embodiment, are not absolute but rather relative directions and though appropriate when the electric wire connector 1 and the substrate connector 101 are at the positions illustrated in the figures, these directions should be interpreted differently when the positions of the electric wire connector 1 and the substrate connector 101 change in correspondence with that change.

Here, the substrate connector 101 is referred to as a header connector and includes: a housing 111 as a counterpart connector main body which consists of an insulating material such as a synthetic resin, is integrally formed, and mates with the electric wire connector 1; and a substrate side terminal 161 as a counterpart terminal including a conductive metal plate which is attached so as to penetrate through a bottom plate part 112 of this housing 111. The housing 111 is a substantially rectangular parallelepiped box shaped member which extends in the direction (which is orthogonal to the mating direction (Z-axis direction) with the electric wire connector 1 and is the arrangement direction of the substrate side terminal 161), that is, in the width direction (Y-axis direction) of the substrate connector 101.

A terminal fitting hole 112b penetrating through this bottom plate part 112 is formed in the bottom plate part 112, wherein the substrate side terminal 161 is fitted into the terminal fitting hole 112b so as to be attached to the bottom plate part 112. Note that the substrate side terminal 161 includes: a solder tail part 162 which extends from below the bottom plate part 112 in the thickness direction of the substrate connector 101, that is, in the anteroposterior direction (X-axis direction) and is electrically connected to a connection pad (not illustrated) formed on the surface of the circuit board, etc. via soldering, etc.; a main body part 163 which is fitted into the terminal fitting hole 112b and held; and a contact part 164 which extends upward from the bottom plate part 112 and contacts an electric wire side terminal 61 of the electric wire connector 1.

Moreover, in the example illustrated in the drawing, although a total of twenty substrate side terminals 161 are arranged in two rows at a predetermined pitch in the width direction of the substrate connector 101, the number of substrate side terminals 161 (that is, the number of poles and the pitch of the substrate side terminals 161) can be optionally changed.

In addition, the housing 111 includes: the substantially rectangular flat plate shaped bottom plate part 112 in a plan view; a pair of side plate parts 113 which extend along the long side of this bottom plate part 112 and stretch upward from the bottom plate part 112; a pair of end plate parts 114 which extend along the short side of the bottom plate part 112 and stretch upward from the bottom plate part 112; and a mating space 115; wherein five surfaces are defined by the bottom plate part 112, the side plate parts 113, and the end plate parts 114, and the upper surface facing the bottom plate part 112 is opened. In addition, the electric wire connector 1 is inserted into and mated with this mating space 115. Note that, in the mating space 115, the contact parts 164 of the substrate side terminals 161 which protrude upward (Z-axis positive direction) from the bottom plate part 112 are arranged in two rows. Moreover, a recessed groove 112a extending in the arrangement direction of the substrate side terminals 161 is formed at the center of two rows of the contact parts 164 of the substrate side terminals 161 on the upper surface of the bottom plate part 112. The lower end of a partition wall 33 possessed by a clip housing 31 of the electric wire connector 1 is inserted into this recessed groove 112a. Further, a mounting nail 171 as a reinforcing metal fitting is attached to the outer surface of the end plate parts 114. A nail tail part 172 formed at the lower end of this mounting nail 171 is fixed to a connection pad (not illustrated) (formed on the surface of the circuit board), etc. via soldering, etc.

Moreover, a locking protrusion 118 protruding into the mating space 115 is formed in the vicinity of the upper ends of the end plate parts 114. This locking protrusion 118 enters and engages with a locking recess 38a, wherein the locking recess 38a is formed in a locking arm 38 which serves as a positive locking member possessed by the clip housing 31 of the electric wire connector 1. Note that a taper part 116 is formed on the surface on the mating space 115 side in the vicinity of the upper ends of the end plate parts 114 and the side plate parts 113. This taper part 116 is an inclined surface (formed such that the size of the mating space 115 increases as it approaches the upper end surface 111a of the housing 111) and exerts a guiding function to smoothly introduce the inserted electric wire connector 1 into the mating space 115. Further, a polar swelling part 117 as a polar key protruding into the mating space 115 is formed at a connection part with the end plate parts 114 on both ends of the side plate parts 113 on the rear side (X-axis negative direction side). When the electric wire connector 1 is nearly inserted into the mating space 115 with the front and rear thereof reversed, the polar swelling part 117 interferes with a polar swelling part 37 as a polar key possessed by the clip housing 31 of the electric wire connector 1, preventing the electric wire connector 1 from being incorrectly inserted into the mating space 115.

In contrast, the electric wire connector 1 includes: a pair of harness housing units 11 as a pair of coupling bodies; a clip housing 31 as a holder to which the harness housing units 11 are capable of being coupled; and an electric wire side terminal 61 as a terminal which is loaded into the harness housing unit 11 and to which the vicinity of the ends of the electric wires 91 are connected. Here, the harness housing unit 11 coupled to the front side (X-axis positive direction side) of the clip housing 31 will be described as a front harness housing unit 11A, while the harness housing unit 11 coupled to the rear side (X-axis negative direction side) of the clip housing 31 will be described as a rear harness housing unit 11B, with both comprehensively described as the harness housing unit 11. In addition, the ends of the electric wires 91 arranged in a single row in the width direction (Y-axis direction) of the electric wire connector 1 are respectively connected to the front harness housing unit 11A and the rear harness housing unit 11B. Consequently, the ends of the electric wires 91 arranged in two rows in the width direction are connected to the electric wire connector 1.

In the present embodiment, the harness housing unit 11 may combine multiple (for example, n) harness housings 11-1, 11-2 . . . 11-n or may include only a single harness housing 11-s. For example, in the example illustrated in FIGS. 1 and 2, the front harness housing unit 11A combines three harness housings 11-1, 11-2, and 11-3, while the rear harness housing unit 11B may include only a single harness housing 11-s. Moreover, in the example illustrated in FIGS. 3A to 5, the rear harness housing unit 11B combines the three harness housings 11-1, 11-2, and 11-3. Note that each harness housing 11-1, 11-2, . . . , 11-n, 11-s will be comprehensively described as a harness housing 11-α.

In the example illustrated in the drawing, the harness housing 11-1 and 11-3 are each connected to the ends of electric wire harnesses including two electric wires 91, the harness housing 11-2 is connected to the ends of electric wire harnesses including four electric wires 91, the harness housing 11-s is connected to the ends of electric wire harnesses including ten electric wires 91, and the electric wire harnesses terminated to the ends of the harness housing 11-α may include any number of electric wires 91. That is, the number of the electric wires 91 terminated at the harness housing 11-α can be optionally set. Further, in other words, the size of the substrate connector 101 of the harness housing 11-α in the width direction (Y-axis direction) can be optionally set in accordance with the number of electric wires 91 (which are contained in the electric wire harnesses terminated to the harness housing 11-α) and electric wire side terminals 61 (which are connected to the electric wires 91), that is, the number of poles, while the aspect in which another harness housing 11-α is combined therewith can be optionally determined in accordance with the set size.

Each harness housing 11-α includes: a main body part 12 as a substantially rectangular parallelepiped shaped housing main body which is integrally formed of an insulating material such as a synthetic resin; and a single or multiple terminal housing recesses 13 formed in this main body part 12. The end of each electric wire 91 and a single electric wire side terminal 61 connected to the end are housed in each terminal housing recess 13. In addition, in the event of multiple terminal housing recesses 13, the terminal housing recesses 13 are arranged in a single row at the same pitch as that of the substrate side terminals 161 in the width direction of the harness housing 11-α, that is, in the width direction of the substrate connector 101. Moreover, the terminal housing recesses 13 are formed from the upper side part 12c to the lower side part 12d of the main body part 12 so as to penetrate through the main body part 12 in the vertical direction (Z-axis direction). Note that a substrate side terminal insertion opening 13a is formed on the lower side part 12d at the position corresponding to each terminal housing recess 13, wherein a front side opening 13b is formed on the front side part 12a of the main body part 12 at the position corresponding to each terminal housing recess 13.

The electric wire side terminal 61 is an integrally formed member consisting of a conductive metal plate including, as illustrated in FIGS. 4A, 4B and 5: a main body part 62; a connection part 65 connected to the upper end of this main body part 62; and a pair of contact parts 64 formed on both sides of the harness housing 11-α in the width direction in the main body part 62. The contact part 64 is a cantilever shaped elastic member, formed by cutting and raising a portion of the main body part 62 that functions as a plate spring, wherein the contact part 164 of the substrate side terminal 161 inserted into the main body part 62 through the substrate side terminal insertion opening 13a is sandwiched from both sides so as to maintain the contact with the contact part 164. With the electric wire side terminal 61 housed in the terminal housing recess 13, the lower end part 62d of the main body part 62 abuts or adjoins the lower surface of the terminal housing recess 13, wherein a lance part 62a as an engaging projection formed on the front side of the main body part 62 protrudes inside the front side opening 13b. The lance part 62a protrudes diagonally upward and is therefore hooked to the upper end of the front side opening 13b, preventing the electric wire side terminal 61 from being drawn out of the terminal housing recess 13. Moreover, the connection part 65, which is the part connected to the end of the electric wire 91, includes: a core metal clamp part 65a which contacts a conductive core metal (not illustrated) (that is exposed downward from the end of the electric wire 91) and clamps this core metal; and a coat clamp part 65b which clamps the periphery of an insulating coating covering the core metal.

Moreover, a main body part rear wall 12h is formed on the rear side part 12b of the main body part 12 of the harness housing 11-α, an insertion housing recess 25 which is opened to the upper side part 12c of the main body part 12 is formed between this main body part rear wall 12h and the rear wall 13c of the terminal housing recess 13, and a slit 25a (which penetrates through the rear wall 13c and is in communication with the terminal housing recess 13 and the insertion housing recess 25) is formed at the position corresponding to the vicinity of the center in the width direction of the harness housing 11-α of the terminal housing recess 13 on the rear wall 13c so as to extend in the vertical direction. Further, an insertion groove 25c is formed at the lower end of the insertion housing recess 25. Further, a friction locking projection 22 is formed at multiple positions in the vicinity of the lower side part 12d on the rear side part 12b. Further, an eaves part 14 protruding from the front side part 12a is formed at the connection part between the front side part 12a and the upper side part 12c of the main body part 12. As illustrated in FIG. 1, with the electric wire connector 1 mating with the inside of the mating space 115, the eaves part 14 covers at least a portion of the part corresponding to the side plate parts 113 at the upper end surface 111a of the housing 111, wherein the lower surface of the eaves part 14 abuts or adjoins the upper end surface 111a. Note that the upper surface of the eaves part 14 is preferably the inclined surface which descends as it is directed outward. As a result, if an operator applies downward force to the upper surface of the eaves part 14 by finger, etc., as illustrated in FIG. 4B, force in the direction of entering a friction locking recess 33a of the partition wall 33 acts on the friction locking projection 22 formed on the rear side part 12b of the harness housing 11-α.

Each clip housing 31 includes: a substantially rectangular flat plate shaped top plate part 32 in a plan view; a pair of end plate parts 34 which extend along the short side of this top plate part 32 and stretch downward from the top plate part 32; a partition wall 33 which stretches downward from the vicinity of the center in the anteroposterior direction of the top plate part 32 and extends in the long side direction (Y-axis direction) of the top plate part 32 so as to be coupled to the end plate parts 34 on both sides; and multiple comb tooth shaped insertion parts 35 which stretch downward from the top plate part 32 and are arranged in parallel in the long side direction of the top plate part 32 so as to form one row at each of the front and rear surfaces of the partition wall 33. Note that multiple recesses 32b are formed on the long side of the top plate part 32 so as to be arranged at the same pitch as that of the terminal housing recesses 13, wherein, with the harness housing unit 11 coupled to the clip housing 31, each recess 32b is disposed so as to correspond to the upper end of each terminal housing recess 13 of the harness housing 11-α, allowing the electric wire 91 to pass therethrough.

In addition, the locking arm 38 as the positive locking member is formed on the outer surface of the end plate parts 34. This locking arm 38 is a cantilever shaped elastically deformable member with the lower end thereof integrally connected to the end plate parts 34 and with the upper end thereof serving as a free end, wherein the locking recess 38a is formed in the vicinity of the upper end, and wherein an eaves operating part 38b which protrudes outward in the width direction (Y-axis direction) of the clip housing 31 is formed at the upper end thereof. As illustrated in FIG. 1, this operating part 38b protrudes outside the end plate parts 114 of the housing 111 with the electric wire connector 1 mating with the inside of the mating space 115, such that an operator can easily operate the operating part 38b by finger, etc. Moreover, the polar swelling part 37 stretching in the vertical direction is formed at the end part of the front side (X-axis positive direction side) of the end plate parts 34. Further, an eaves part 32a protruding outward from the top plate part 32 in the width direction of the clip housing 31 is formed at the upper end of the end part on the front and rear sides of the end plate parts 34. As illustrated in FIG. 1, with the electric wire connector 1 mating with the inside of the mating space 115, the eaves part 32a covers at least a portion of the part corresponding to end plate parts 114 and the side plate parts 113 at the upper end surface 111a of the housing 111, wherein the lower surface of the eaves part 32a abuts or adjoins the upper end surface 111a.

Moreover, the friction locking recess 33a is formed at multiple positions in the vicinity of the lower end of the partition wall 33. As illustrated in FIG. 4B, with the harness housing unit 11 coupled to the clip housing 31, the friction locking projection 22 formed at the rear side part 12b of the harness housing 11-α engages with the friction locking recess 33a. Note that the lower end of the partition wall 33 protrudes below the lower side part 12d of the harness housing 11-α, with the harness housing unit 11 coupled to the clip housing 31, and is inserted into the recessed groove 112a formed at the bottom plate part 112 of the housing 111 when the electric wire connector 1 mates with the inside of the mating space 115.

Further, the insertion parts 35 are arranged in parallel at the same pitch as the pitch of the terminal housing recesses 13 in the width direction of the harness housing 11-α, that is, in the long side direction of the top plate part 32. Each insertion part 35 includes: an elongated strip shaped base part 35b which stretches downward; and a rib part 35a which stretches downward from the center in the width direction (Y-axis direction) of this base part 35b in the opposite direction of the partition wall 33. Note that the lower end of the base part 35b protrudes below the lower end of the rib part 35a. Moreover, the insertion part 35 is formed so as to be separated from the front and rear surfaces of the partition wall 33, wherein a rear stop gap 35c is formed between the base part 35b and the front and rear surfaces of this partition wall 33. As illustrated in FIGS. 4A and 5, with the harness housing unit 11 coupled to the clip housing 31, an insertion part 35 is disposed so as to correspond to each terminal housing recess 13. In addition, the vicinity of the upper end of the rear side part 12b of the harness housing 11-α is inserted into the rear stop gap 35c, the vicinity of the lower end of the base part 35b is inserted into the insertion groove 25c of the insertion housing recess 25, and the rib part 35a is inserted into the slit 25a such that at least a portion thereof protrudes inside the terminal housing recess 13. The part which protrudes into the terminal housing recess 13 at the lower end of the rib part 35a is disposed above the upper end part 62c in the main body part 62 of the electric wire side terminal 61 housed in the terminal housing recess 13, preventing the electric wire side terminal 61 from being drawn out of the terminal housing recess 13.

That is, the base part 35b of the insertion part 35 is inserted into the insertion housing recess 25, and further, the friction locking projection 22 engages with the friction locking recess 33a such that the harness housing unit 11 is attached to the clip housing 31. At this time, the rib part 35a as a retainer prevents the electric wire side terminal 61 from being drawn out of the terminal housing recess 13.

Note that, in the present embodiment, the rib part 35a as a retainer is inserted into the slit 25a with a portion thereof protruding inside the terminal housing recess 13, wherein, in order to couple the harness housing unit 11 and the clip housing 31, another configuration of the retainer may be provided, while the configuration of the rib part 35a and the rear wall 13c need not be provided.

Next, the configuration of the electric wire connector 1 will be described.

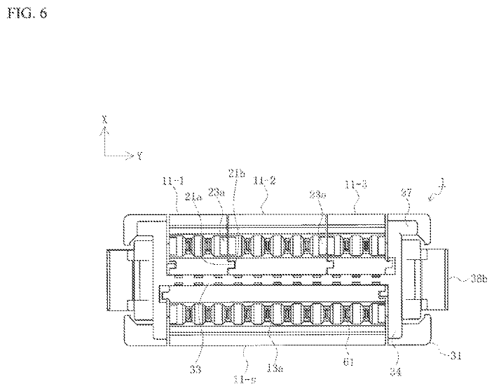

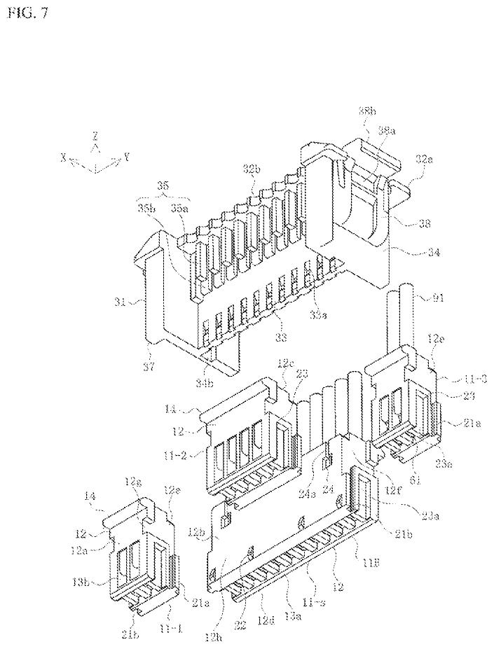

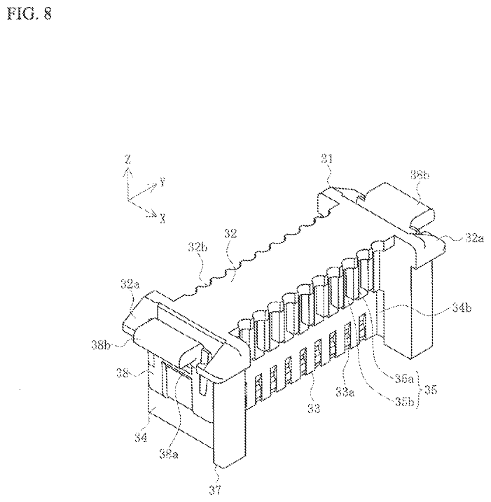

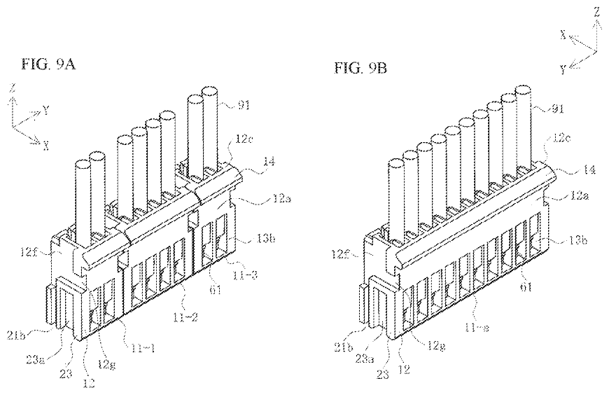

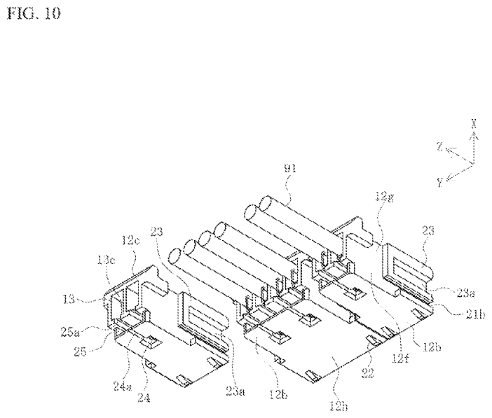

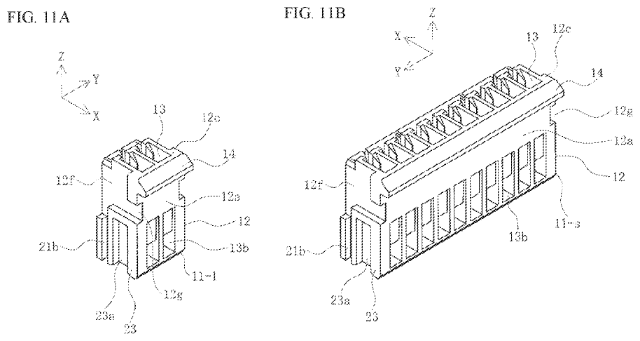

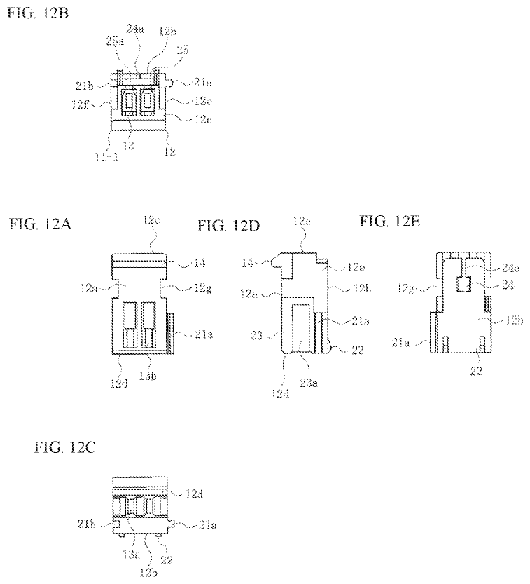

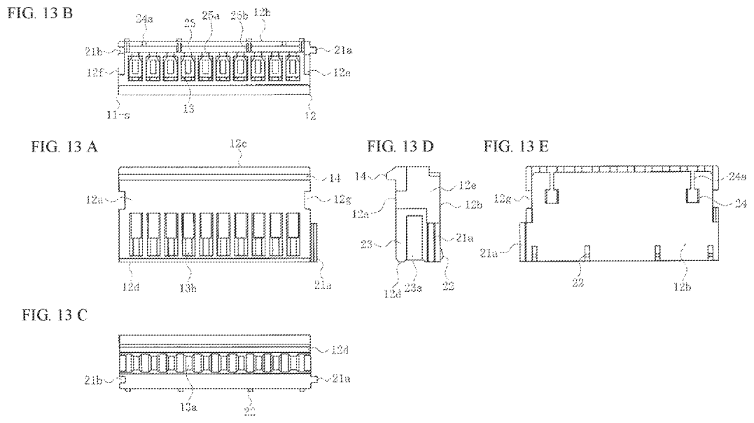

FIG. 6 is a bottom view of the connector in Embodiment 1, FIG. 7 is an exploded view of the connector in Embodiment 1, FIG. 8 is a perspective view of a clip housing in Embodiment 1, FIGS. 9A and 9B are perspective views of a harness housing unit of the connector in Embodiment 1, FIG. 10 is a partially exploded view of the harness housing unit of the connector in Embodiment 1, FIGS. 11A and 11B are perspective views of a harness housing of the connector in Embodiment 1, FIGS. 12A-12E are five-plane drawings of the harness housing with a small number of poles in Embodiment 1, and FIGS. 13A-13E are five-plane drawings of the harness housing with a large number of poles in Embodiment 1. Note that, in FIGS. 9A and 9B, FIG. 9A is a perspective view of a front harness housing unit, while FIG. 9B is a perspective view of a rear harness housing unit, in FIGS. 11A and 11B, FIG. 11A is a perspective view of a harness housing with a small number of poles, while FIG. 11B is a perspective view of a harness housing with a large number of poles, and in FIGS. 12A-12E and 13A-13E, FIGS. 12A and 13A are front views, FIGS. 12B and 13B are top views, FIGS. 12C and 13C are bottom views, FIGS. 12D and 13D are side views, and FIGS. 12E and 13E are back views.

Here, as in the example illustrated in FIGS. 1 and 2, a case will be described in which the front harness housing unit 11A combines three harness housings 11-1, 11-2, and 11-3, while the rear harness housing unit 11B may include only a single harness housing 11-s. Note that, in FIGS. 9B and 11B, the front side part 12a of the main body part 12 of the harness housing 11-s is directed rearward (X-axis negative direction). In addition, as illustrated in FIGS. 6 and 7, the front harness housing unit 11A and the rear harness housing unit 11B are respectively coupled to the front and rear sides of the clip housing 31.

Note that, as mentioned above, as illustrated in FIGS. 7 and 8, the insertion part 35 including the rib part 35a (wherein a portion thereof protrudes into the terminal housing recess 13 so as to face the upper end of the main body part 62 of the electric wire side terminal 61) (which exerts the function of preventing the electric wire side terminal 61 from being drawn out of the terminal housing recess 13) is integrally connected to the top plate part 32 while arranged in parallel in the long side direction of the top plate part 32 of the clip housing 31. Consequently, regarding the insertion part 35 and the top plate part 32, the rib part 35a functions as a retainer which prevents the electric wire side terminal 61 from being drawn out, wherein the clip housing 31 in the present embodiment includes an integrally formed retainer.

In the present embodiment, the main body part 12 of the harness housing 11-α includes: the front side part 12a; the rear side part 12b; and the left side part 12e (as a first side part) and the right side part 12f (as a second side part) which connects both ends in the width direction of the substrate connector 101 on the upper side part 12c and the lower side part 12d. In addition, a coupling rib 21a, which protrudes outward in the width direction of the substrate connector 101 and stretches in the vertical direction, is formed on the left side part 12e, while a coupling groove 21b, which is recessed inward in the width direction of the substrate connector 101 and stretches in the vertical direction, is formed on the right side part 12f. If multiple harness housings 11-α are combined, the left side part 12e and the right side part 12f of adjacent harness housings 11-α face each other and the coupling rib 21a is inserted into the coupling groove 21b so as to couple the coupling rib 21a and the coupling groove 21b by friction. As a result, adjacent harness housings 11-α are mutually coupled. For example, in the front harness housing unit 11A, the coupling rib 21a formed on the left side part 12e of the harness housing 11-1 is inserted into the coupling groove 21b formed on the right side part 12f of the harness housing 11-2, while the coupling rib 21a formed on the left side part 12e of the harness housing 11-2 is inserted into the coupling groove 21b formed on the right side part 12f of the harness housing 11-3, such that both of them are mutually coupled. Note that, irrespective of the number of poles, the coupling rib 21a and the coupling groove 21b are preferably formed on the left side part 12e and the right side part 12f of all the harness housings 11-α. Moreover, a recessed groove 34b capable of housing the coupling rib 21a is preferably formed at the position facing the coupling rib 21a at the inner surface of the end plate parts 34 of the clip housing 31. The mutually coupled harness housings 11-α or the clip housing 31 and the harness housing unit 11 are coupled by friction, allowing them to be separated if a force separating them from each other is applied.

Further, a projection 23 protruding outward in the width direction of the substrate connector 101 is formed on the left side part 12e and the right side part 12f of the harness housings 11-α. Note that the protrusion amount of this projection 23 is set so as to be smaller than the protrusion amount of the coupling rib 21a. In addition, a recess 23a as a void recess (which is opened at the lower side part 12d and stretches upward from the lower side part 12d) is formed in the projection 23. When the left side part 12e and the right side part 12f of adjacent harness housings 11-α face each other and are coupled, recesses 23a of left and right harness housings 11-α are combined so as to form a void space into which the contact parts 164 of the substrate side terminals 161 of the substrate connector 101 is capable of entering. This void space is a space which is disposed in the middle between the leftmost side terminal housing recess 13 in the right side harness housing 11-α and the rightmost side terminal housing recess 13 in the left side harness housing 11-α and opened on the lower side part 12d. That is, the interval between the void space and the terminal housing recess 13 adjacent to this void space is identical to the pitch of the terminal housing recesses 13 and the pitch of the substrate side terminals 161. Consequently, when the harness housing unit 11 (in which multiple harness housings 11-α are combined) is inserted into the mating space 115 of the substrate connector 101, the contact parts 164 of the substrate side terminals 161 corresponding to the coupling part of adjacent harness housings 11-α enter a void space including the recesses 23a. As a result, even if the aspect of combining the harness housings 11-α is optionally changed and the position of the coupling part of adjacent harness housings 11-α is changed, the same substrate connector 101 can be continually used without removing the substrate side terminals 161 present at the position of the coupling part.

Moreover, a locking recess 12g is formed on both the left and right sides of the front side part 12a in the main body part 12 of the harness housing 11-α. Further, a single or multiple locking openings 24 as well as a slit 24a (which stretches upward from the locking openings 24 and reaches the upper end of the main body part rear wall 12h) are formed on the main body part rear wall 12h of the main body part 12. The insertion housing recess 25 is in communication with the outside of the main body part rear wall 12h via the locking openings 24 and the slit 24a. Note that, in the case of the harness housing 11-s, which has a relatively large number of poles and a relatively large size in the width direction (Y-axis direction) of the substrate connector 101, as illustrated in FIG. 13B, a support part 25b which couples the main body part rear wall 12h of the main body part 12 and the rear wall 13c of the terminal housing recess 13 is formed in the insertion housing recess 25. When the main body part rear wall 12h is coupled to the rear wall 13c by this support part 25b, the deflection of the main body part rear wall 12h which serves as a member having a plate shape and spring properties can be controlled. Note that the number and position of the support part 25b is not limited to the example illustrated in the figure and can be appropriately changed.

Next, the operation of allowing the electric wire connector 1 to mate with the substrate connector 101 will be described.

First, the operation of combining multiple harness housings 11-α so as to configure the harness housing unit 11, in addition to further coupling multiple harness housing units 11 to the clip housing 31 so as to configure the electric wire connector 1, will be described. Here, as illustrated in FIGS. 1 and 2, an example will be described, wherein three harness housings 11-1, 11-2, and 11-3 are combined so as to configure the front harness housing unit 11A, and wherein, with the rear harness housing unit 11B serving as one which consists only of a single harness housing 11-s, the front harness housing unit 11A and the rear harness housing unit 11B are coupled to the clip housing 31.

An operator inserts the coupling rib 21a (formed on the left side part 12e of the harness housing 11-1) into the coupling groove 21b (formed on the right side part 12f of the harness housing 11-2) and inserts the coupling rib 21a (formed on the left side part 12e of the harness housing 11-2) into the coupling groove 21b (formed on the right side part 12f of the harness housing 11-3) so as to configure the front harness housing unit 11A as illustrated in FIG. 9A. Moreover, the harness housing 11-s is used as the rear harness housing unit 11B as is.

Subsequently, the operator relatively raises the front harness housing unit 11A from below the clip housing 31 so as to couple it to the front side of the clip housing 31. In this case, the surface of the rear side part 12b in the main body part 12 of each of the harness housings 11-1, 11-2, and 11-3 is relatively raised while sliding along the front surface of the partition wall part 33 of the clip housing 31. In addition, the base part 35b and the rib part 35a in the insertion part 35 of the relatively descending clip housing 31 are inserted from above into the insertion housing recess 25 and the slit 25a in the main body part 12, while the rear side part 12b is inserted from below into the rear stop gap 35c between the front surface of the partition wall 33 and the base part 35b. As a result, as illustrated in FIG. 2, the front harness housing unit 11A is coupled to the front side of the clip housing 31. Moreover, the operator similarly couples the rear harness housing unit 11B to the rear side of the clip housing 31. As a result, the electric wire connector 1 as illustrated in FIG. 2 is configured. Because a configuration is employed in which the harness housings 11-1, 11-2, and 11-3 are attached to the clip housing 31 so as to be raised thereto, with the coupling rib 21a and the coupling groove 21b directed in the vertical direction, each one of the harness housings 11-1, 11-2, and 11-3 can be attached to the clip housing 31, enabling the operation to be selected. Note that a configuration in which the harness housings 11-1, 11-2, and 11-3 are attached to the clip housing 31 so as to be raised thereto allows even a single harness housing 11-α to be fixed to the clip housing 31, for example, by a configuration in which the vicinity of the upper end of the rear side part 12b is inserted into the rear stop gap 35c as well as a configuration in which the friction locking projection 22 engages with the friction locking recess 33a.

Subsequently, as illustrated in FIG. 2, the operator relatively lowers the electric wire connector 1 from above the substrate connector 101, inserting it into and allowing it to mate with the mating space 115 of the substrate connector 101. At this time, the position of the electric wire connector 1 relative to the substrate connector 101 is controlled such that the front side of the electric wire connector 1 (that is, the side on which a pair of polar swelling parts 37 are present) is directed to the front side of the substrate connector 101 (that is, the side on which a pair of polar swelling parts 117 are not present).

Hence, the contact part 164 of each substrate side terminal 161 of the substrate connector 101 is inserted from below into the corresponding terminal housing recess 13 of the main body part 12 of the harness housing 11-α and contacts the contact parts 64 of the electric wire side terminal 61 housed in this terminal housing recess 13 so as to be conducted. Note that the front harness housing unit 11A is configured by combining three harness housings 11-1, 11-2, and 11-3, wherein not the terminal housing recess 13, but rather a void space configured by combining the recesses 23a is present at the coupling part between the harness housing 11-1 and the harness housing 11-2 which are mutually adjacent as well as at the coupling part between the harness housing 11-2 and the harness housing 11-3, as illustrated in FIG. 6. Therefore, the contact parts 164 of the substrate side terminals 161 corresponding to the coupling part are inserted not into the terminal housing recess 13 but rather into the void space including the recesses 23a.

Further, the operator presses the electric wire connector 1 relatively downward so as to allow the locking protrusion 118 in the mating space 115 to engage with the locking recess 38a formed in the locking arm 38. As a result, the electric wire connector 1 and the substrate connector 101 are locked in a mated state, preventing unnecessary mating release.

In this manner, in the present embodiment, the electric wire connector 1 includes: a clip housing 31; and a harness housing unit 11 coupled to the clip housing 31, wherein the harness housing unit 11 includes multiple harness housings 11-α connected to the ends of the electric wire harnesses including electric wires 91. This allows multiple electric wire harnesses to be integrated into a single electric wire connector 1, allows for a reduction in the number of parts, allows for a reduction in the workload necessary for the mating between the electric wire connector 1 and the substrate connector 101, and allows for a reduction in manufacturing costs.

Moreover, each harness housing 11-α includes a terminal housing recess 13 which houses the electric wire side terminal 61 connected to the ends of electric wires 91, while the clip housing 31 includes a top plate part 32 and an insertion part 35 which function as retainers to prevent the electric wire side terminal 61 from being drawn out of the terminal housing recess 13. Consequently, even if the external force pulling the electric wires 91 is imparted to the electric wire harnesses, the electric wire side terminal 61 is prevented from being drawn out of the terminal housing recess 13.

Further, the harness housing unit 11 is configured by coupling adjacent harness housings 11-α in the width direction. As a result, the harness housing unit 11 can be configured by optionally combining the harness housings 11-α.

Further, the harness housing 11-α includes: the coupling rib 21a formed on the left side part 12e; and the coupling groove 21b which is formed on the right side part 12f and into which the coupling rib 21a is capable of being inserted. Consequently, when the coupling rib 21a of the adjacent harness housing 11-α is only inserted into the coupling groove 21b of the harness housing 11-α, the harness housings 11-α can be easily coupled.

Further, the harness housing 11-α includes: the projection 23 formed on the left side part 12e and the right side part 12f; and the recess 23a formed on the projection 23, wherein the void space into which the substrate side terminals 161 are capable of entering is configured by the recess 23a between the left side part 12e the right side part 12f of mutually coupled adjacent harness housings 11-α. As a result, the aspect combining the harness housings 11-α is changed and the position of the coupling part of adjacent harness housings 11-α is changed, allowing the substrate connector 101 having the same specifications to be continually used without having to remove the substrate side terminals 161 (present at the position of the coupling part) from the substrate connector 101.

Further, the clip housing 31 includes the partition wall 33 extending in the width direction, wherein each harness housing unit 11 is coupled to both sides of the partition wall 33. Consequently, a large number of electric wire harnesses can be integrated into a single electric wire connector 1.

Further, the friction locking recess 33a is formed on the partition wall 33, wherein the friction locking projection 22 (which is formed in the harness housing 11-α possessed by harness housing units 11 on both sides of the partition wall 33) engages with the friction locking recess 33a. As a result, the friction locking projection 22 and the friction locking recess 33a coordinate with the top plate part 32 and the insertion part 35 which function as retainers, allowing the harness housing units 11 to be assuredly coupled to the clip housing 31.

Further, the clip housing 31 includes the end plate parts 34 connected to both ends of the partition wall 33, wherein the locking arm 38 (which includes the locking recess 38a capable of engaging with the locking protrusion 118 of a substrate side connector 101) is formed on the outer surface of the end plate parts 34. As a result, the electric wire connector 1 and the substrate connector 101 are locked in a mated state, preventing unnecessary mating release.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

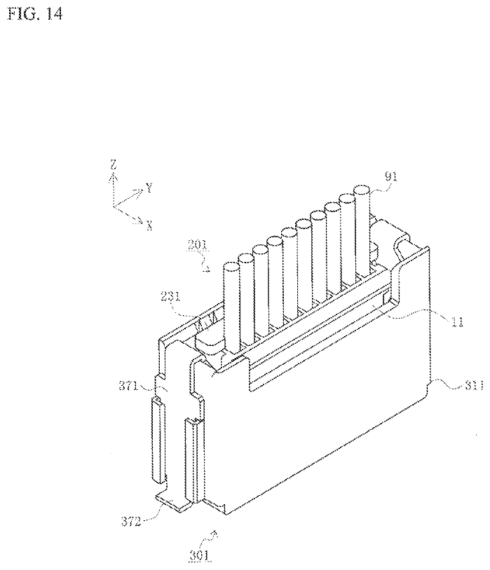

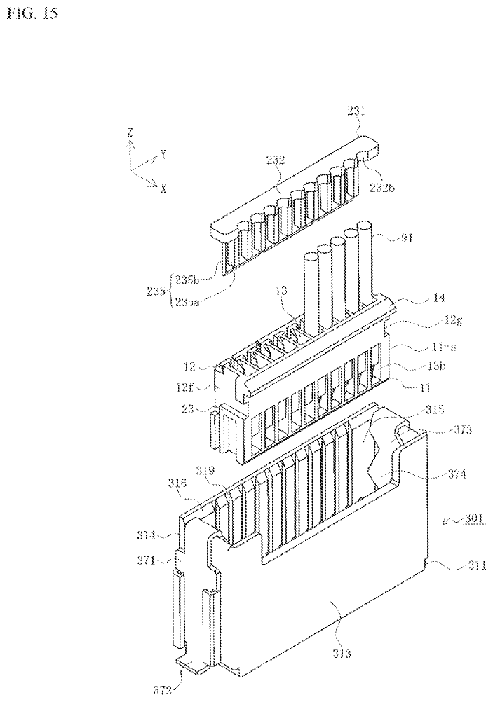

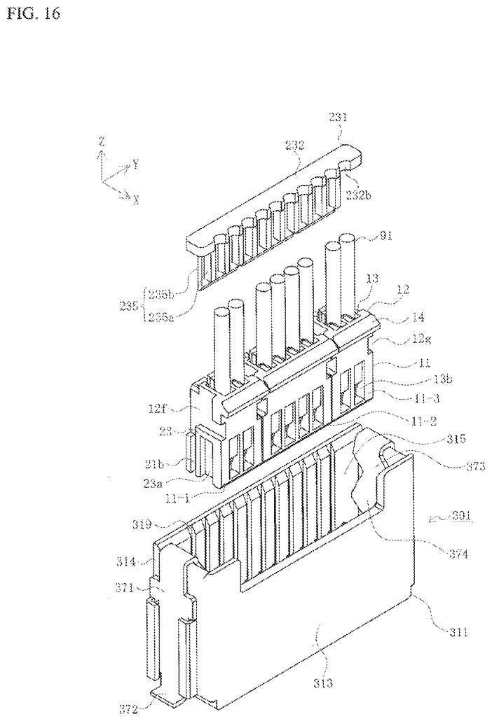

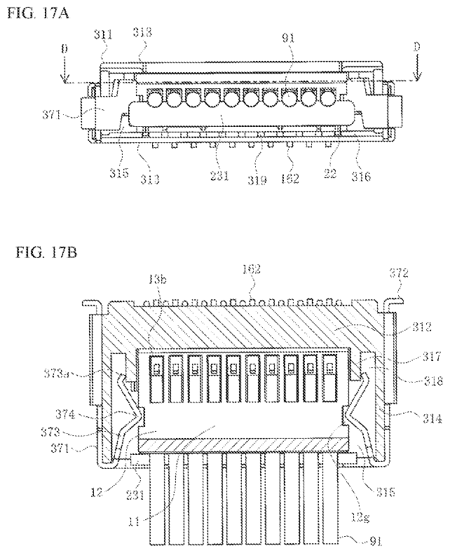

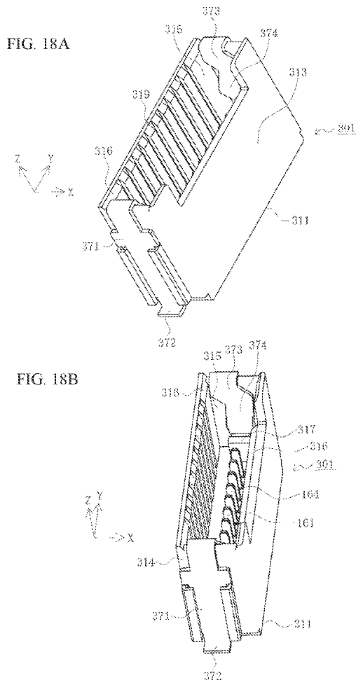

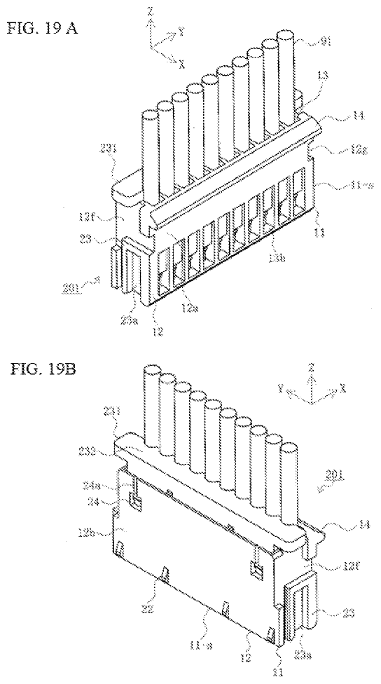

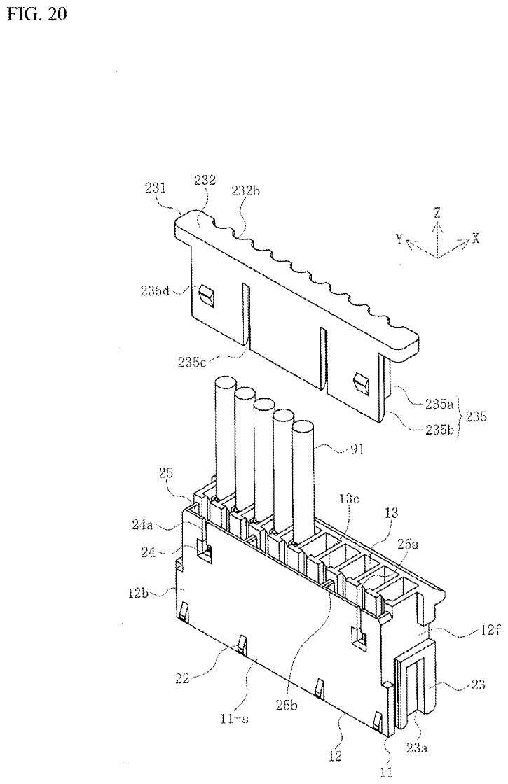

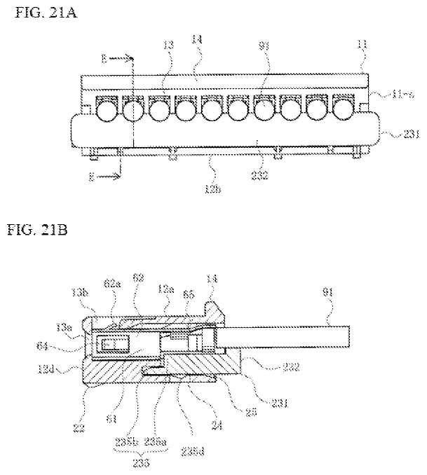

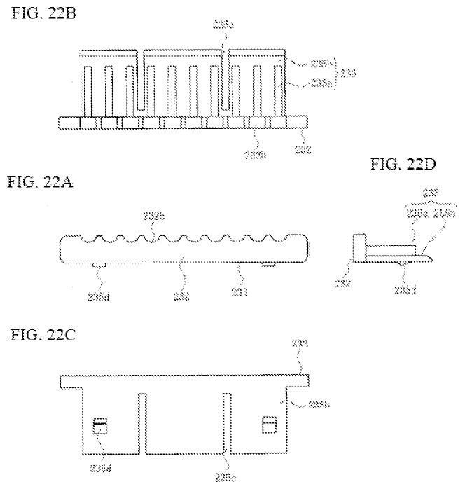

FIG. 14 is a perspective view of a connector assembly in Embodiment 2, FIG. 15 is a first exploded view of the connector assembly in Embodiment 2, FIG. 16 is a second exploded view of the connector assembly in Embodiment 2, FIGS. 17A and 17B are two-plane drawings of the connector assembly in Embodiment 2, FIGS. 18A and 18B are perspective views of a substrate connector in Embodiment 2, FIGS. 19A and 19B are perspective views of an electric wire connector in Embodiment 2, FIG. 20 is an exploded view of the electric wire connector in Embodiment 2, FIGS. 21A and 21B are two-plane drawings of the electric wire connector in Embodiment 2, and FIGS. 22A-22D are four-plane drawings of a holder including a retainer member in Embodiment 2. Note that, in FIGS. 17A and 17B, FIG. 17A is a top view, while FIG. 17B is a cross sectional view in the arrow direction along line D-D in 17A, in FIGS. 18A and 18B, FIG. 18A is a view viewed from the first angle, while FIG. 18B is a perspective view viewed from the second angle, in FIGS. 19A and 19B, FIG. 19A is a perspective view viewed from the front, while FIG. 19B is a perspective view viewed from the rear, in FIGS. 21A and 21B, FIG. 21A is a top view, while FIG. 21B is a cross sectional view in the arrow direction along line E-E in FIG. 21A, and in FIGS. 22A-22D, FIG. 22A is a top view, FIG. 22B is a front view, FIG. 22C is a rear view, and FIG. 22D is a side view.

The present embodiment is applied to a case in which the harness housing 11-α in Embodiment 1 is utilized across the board and arranged in a single row in the width direction to form one harness housing unit 11. In contrast, if one harness housing unit 11, which is arranged in a single row, is used as a single connector and a large number of electric wire harnesses are connected to a circuit board, multiple electric wire connectors and substrate connectors are required to be prepared, such that not only the number of parts but also the workload for allowing the electric wire connectors to mate with the substrate connectors increases, leading to an increase in manufacturing costs. The present embodiment is specifically configured in order resolve such problems.

201 is an electric wire connector as a connector in the present embodiment and is connected to the ends of electric wire harnesses including multiple electric wires 91 as in the electric wire connector 1 in Embodiment 1, wherein the electric wire connector 1 in Embodiment 1 has two harness housing units 11 and the ends of the electric wires 91, which are arranged in two rows in the width direction 2, are connected, while the electric wire connector 201 in the present embodiment has a single harness housing unit 11 and the ends of the electric wires 91, which are arranged in a single row in the width direction, are connected.

Moreover, 301 is a substrate connector as a counterpart connector in the present embodiment and is mounted on a circuit board as a substrate (not illustrated). In addition, the electric wire connector 201 and the substrate connector 301 are capable of mutually mating so as to configure a connector assembly in the present embodiment. Note that the substrate connector 301 is a so-called straight type connector and mounted while erected toward the circuit board, that is, while opened upward. In addition, the electric wire connector 201 is vertically mated with the substrate connector 301, consequently allowing the electric wires 91 to be vertically pulled out to the circuit board.

Moreover, expressions for indicating directions such as up, down, left, right, front, and back, used to describe the operations and configurations of the parts of the electric wire connector 201 and the substrate connector 301 in the present embodiment, are not absolute but rather relative directions, and though appropriate when the electric wire connector 201 and the substrate connector 301 are at the positions illustrated in the figures, these directions should be interpreted differently when the positions of the electric wire connector 201 and the substrate connector 301 change in correspondence with that change.

The substrate connector 301 is referred to as a header connector and includes: a housing 311 as a counterpart connector main body which consists of an insulating material such as a synthetic resin, is integrally formed, and mates with the electric wire connector 201; and a substrate side terminal 161 as a counterpart terminal including a conductive metal plate which is attached so as to penetrate through a bottom plate part 312 of this housing 311. The housing 311 is a substantially rectangular parallelepiped box shaped member which extends in the direction (which is orthogonal to the mating direction (Z-axis direction) with the electric wire connector 201 and is the arrangement direction of the substrate side terminal 161), that is, in the width direction (Y-axis direction) of the substrate connector 301.

A terminal fitting hole (not illustrated) penetrating through this bottom plate part 312 is formed in the bottom plate part 312, wherein the substrate side terminal 161 is fitted into the terminal fitting hole so as to be attached to the bottom plate part 312. Note that the substrate side terminals 161 are identical to the substrate side terminals 161 in Embodiment 1.

Moreover, in the example illustrated in the drawing, although a total of ten substrate side terminals 161 are arranged in a single row at a predetermined pitch in the width direction of the substrate connector 301, the number of substrate side terminals 161 (that is, the number of poles and the pitch of the substrate side terminals 161) can be optionally changed.

In addition, the housing 311 includes: the substantially rectangular flat plate shaped bottom plate part 312 in a plan view; a pair of side plate parts 313 which extend along the long side of this bottom plate part 312 and stretch upward from the bottom plate part 312; a pair of end plate parts 314 which extend along the short side of the bottom plate part 312 and stretch upward from the bottom plate part 312; and a mating space 315 wherein five surfaces are defined by the bottom plate part 312, the side plate parts 313, and the end plate parts 314, and wherein the upper surface facing the bottom plate part 312 is opened. In addition, the electric wire connector 201 is inserted into and mated with this mating space 315. Note that, in the mating space 315, the contact parts 164 of the substrate side terminals 161 which protrude upward (Z-axis positive direction) from the bottom plate part 312 are arranged in a single row.

Moreover, a mounting nail 371 as a reinforcing metal fitting is attached to the end plate parts 314. A nail tail part 372 formed at the lower end of this mounting nail 371 is fixed to a connection pad (not illustrated) (formed on the surface of the circuit board), etc. via soldering, etc. Moreover, a locking arm 373 as a friction locking member, which wraps around the upper end of the end plate parts 314 and stretches into the mating space 315, is connected to the upper end of the mounting nail 371. This locking arm 373 is a cantilever shaped plate spring member in which the upper end serving as a base end is fixed and the tip 373a serving as a free end stretches downward, wherein a locking projection 374 protruding towards the center of the substrate connector 301 in the width direction is formed between the upper end and the tip 373a. This locking projection 374 enters and engages with the locking recess 12g which is formed on both the left and right sides of the front side part 12a in the main body part 12 of the harness housing 11-α of the electric wire connector 201. Note that a lock regulating protrusion 317 which stretches upward is formed in the vicinity of the end plate parts 314 at the upper surface of the bottom plate part 312, with the tip 373a of the locking arm 373 housed in a lock regulating recess 318 between the lock regulating protrusion 317 and the end plate parts 314, consequently regulating the position of the locking projection 374 in the width direction of the substrate connector 301.

Further, multiple friction locking projection housing grooves 319 stretching in the vertical direction are formed on the surface on the mating space 315 side of the rear side plate parts 313. When the electric wire connector 201 is inserted into the mating space 315, the friction locking projection 22 formed on the rear side part 12b of the harness housing 11-α of the electric wire connector 201 is housed in the friction locking projection housing groove 319. Note that a taper part 316 is formed on the surface on the mating space 315 side in the vicinity of the upper ends of the front and rear side plate parts 313. This taper part 316 is an inclined surface (which is formed such that the size of the mating space 315 increases as it approaches the upper end of the housing 311) and exerts a guiding function to smoothly introduce the inserted electric wire connector 201 into the mating space 315.

In contrast, the electric wire connector 201 includes: harness housing units 11 as coupling bodies; a holder 231 to which the harness housing units 11 are capable of being coupled; and an electric wire side terminal 61 as a terminal which is loaded into the harness housing unit 11 and to which the vicinity of the ends of the electric wires 91 are connected.

In the present embodiment, as in Embodiment 1, the harness housing unit 11 may combine multiple harness housings 11-α or may include only a single harness housing 11-α. That is, as illustrated in FIG. 15, a single harness housing 11-s may be used as the harness housing unit 11 as is, or as illustrated in FIG. 16, three harness housings 11-1,11-2, and 11-3 may be combined to configure the harness housing unit 11. Here, for convenience of description, the case will be described in which the single harness housing 11-s is used as the harness housing unit 11 as is. Note that the harness housing 11-α is identical to that in Embodiment 1, with the description thereof therefore omitted. Moreover, the electric wire side terminal 61, which is housed in the terminal housing recess 13 formed in the main body part 12 of the harness housing 11-α, is identical to that in Embodiment 1, so the description thereof is therefore omitted.

The holder 231 includes: a substantially rectangular flat plate shaped top plate part 232 in a plan view; a base part 235b which stretches downward along the long side of the rear side of this top plate part 232 and extends in the long side direction (Y-axis direction) of the top plate part 232; and an insertion part 235 including a rib part 235a which protrudes from the surface on the front side of this base part 235b and stretches downward. Multiple rib parts 235a are arranged in a single row in the long side direction of the top plate part 232 at the same pitch as that of the terminal housing recess 13. Note that the lower end of the base part 235b protrudes below the lower end of the rib part 235a. Regarding the insertion part 235 and the top plate part 232, the rib part 235a functions as a retainer which prevents the electric wire side terminal 61 from being drawn out, wherein the holder 231 in the present embodiment includes an integrally formed retainer.

Moreover, multiple support part housing slits 235c (which are opened at the lower end and extend upward) are formed at the base part 235b, while multiple locking protrusions 235d are formed on the surface on the rear side of the base part 235b. Further, multiple recesses 232b are formed on the long side of the front side of the top plate part 232 so as to be arranged at the same pitch as that of the terminal housing recesses 13, wherein, with the harness housing unit 11 coupled to the holder 231, each recess 232b is disposed so as to correspond to the upper end of each terminal housing recess 13 of the harness housing 11-α, allowing the electric wire 91 to pass therethrough. Note that, in terms of commonality, the base parts 235b may each be independent as in the base part 35b in Embodiment 1.

As illustrated in FIGS. 19A, 19B, 21A and 21B, with the holder 231 coupled to the harness housing unit 11, the rib part 235a is disposed so as to correspond to each terminal housing recess 13. In addition, the base part 235b of the insertion part 235 is inserted into the insertion housing recess 25 of the harness housing 11-α, while the rib part 235a is inserted into the slit 25a such that at least a portion thereof protrudes into the terminal housing recess 13. The part which protrudes into the terminal housing recess 13 at the lower end of the rib part 235a is disposed above the upper end part 62c in the main body part 62 of the electric wire side terminal 61 housed in the terminal housing recess 13, preventing the electric wire side terminal 61 from being drawn out of the terminal housing recess 13. Moreover, because the locking protrusions 235d engage with the locking openings 24 of the harness housing 11-α, the holder 231 and the harness housing unit 11 are mutually locked so as to assuredly maintain the coupling between the holder 231 and the harness housing unit 11. Further, the holder 231 and the harness housing unit 11 can be easily coupled and decoupled. Note that, even if the support part 25b which couples the rear side part 12b of the main body part 12 and the rear wall 13c of the terminal housing recess 13 is formed in the insertion housing recess 25, this support part 25b is housed in the support part housing slits 235c, allowing the base part 235b to be inserted into the insertion housing recess 25.

In addition, if the electric wire connector 201 mates with the substrate connector 301, an operator relatively lowers the electric wire connector 201 (in which the holder 231 is coupled to the harness housing unit 11 as illustrated in FIGS. 19A, 19B, 21A and 21B) from above the substrate connector 301, inserting it into and allowing it to mate with the mating space 315 of the substrate connector 301. In this case, the position of the electric wire connector 201 relative to the substrate connector 301 is controlled such that the rear side of the electric wire connector 201 (that is, the side on which the friction locking projection 22 is present) is directed to the rear side of the substrate connector 301 (that is, the side on which the friction locking projection housing groove 319 is formed on the surface on the mating space 315 side of the side plate parts 313). As a result, because the friction locking projection 22 is housed in the friction locking projection housing groove 319, the electric wire connector 201 can be inserted into the mating space 315. That is, in the present embodiment, the friction locking projection 22 and the friction locking projection housing groove 319 function as a polar key function for preventing the electric wire connector 201 from being incorrectly inserted into the mating space 315.

Hence, the contact part 164 of each substrate side terminal 161 of the substrate connector 301 is inserted from below into the corresponding terminal housing recess 13 of the main body part 12 of the harness housing 11-α, contacting the contact parts 64 of the electric wire side terminal 61 housed in this terminal housing recess 13 so as to be conducted.

Further, the operator presses the electric wire connector 201 relatively downward so as to allow the locking projection 374 of the locking arm 373 in the mating space 315 to engage with the locking recess 12g formed on both the left and right sides of the harness housing 11-α. As a result, the electric wire connector 201 and the substrate connector 301 are locked in a mated state, preventing unnecessary mating release.

In this manner, in the present embodiment, the electric wire connector 201 includes: a holder 231; and a harness housing unit 11 coupled to the holder 231, wherein the harness housing unit 11 includes multiple harness housings 11-α connected to the ends of the electric wire harnesses including electric wires 91. This allows multiple electric wire harnesses to be integrated into a single electric wire connector 201, allows for a reduction in the number of parts, allows for a reduction in the workload necessary for the mating between the electric wire connector 201 and the substrate connector 301, and allows for a reduction in manufacturing costs.

Moreover, each harness housing 11-α includes a terminal housing recess 13 which houses the electric wire side terminal 61 connected to the ends of electric wires 91, while the holder 231 includes a top plate part 232 and an insertion part 235 which function as retainers to prevent the electric wire side terminal 61 from being drawn out of the terminal housing recess 13. Consequently, even if the external force pulling the electric wires 91 is imparted to the electric wire harnesses, the electric wire side terminal 61 is prevented from being drawn out of the terminal housing recess 13.

The configuration, operation, and effects of the other points of the electric wire connector 201 and the substrate connector 301 according to the present embodiment are the same as the electric wire connector 1 and the substrate connector 101 of Embodiment 1, and therefore descriptions thereof have been omitted.

Note that the present disclosure is only one example and can be appropriately changed as long as the spirit of the present disclosure is maintained, such that those which could have easily been conceived of by a person skilled in the art are included in the scope of the present disclosure. The width, thickness, shape, etc. of the parts illustrated in the drawings are schematically represented and do not limit the interpretation of the present disclosure.

Moreover, the disclosure herein describes features relating to suitable exemplary embodiments. Various other embodiments, modifications, and variations within the scope and spirit of Scope of the Patent Claims appended hereto will naturally be conceived of by those skilled in the art upon review of the disclosure herein.

The present disclosure can be applied to a connector and a connector assembly.

1. (a) A connector, comprising: a holder; and a harness housing unit coupled to the holder;
(b) wherein the harness housing unit includes multiple harness housings connected to the ends of electric wire harnesses including electric wires and is configured by coupling adjacent harness housings in the width direction.

2. The connector according to claim 1, wherein:
each of the harness housings includes a terminal housing recess which houses terminals connected to the ends of the electric wires, and
the holder includes an insertion part that is inserted into each of the harness housings.

3. The connector according to claim 2, wherein the insertion part includes a retainer which prevents the terminals from being drawn out of the terminal housing recess.

4. The connector according to claim 1, wherein the harness housing includes: a coupling rib formed on a first side part; and a coupling groove which is formed on a second side part and into which the coupling rib is capable of being inserted.

5. The connector according to claim 1, wherein the harness housing includes: a projection which is formed on the first and second side parts; and a recess formed on this projection; wherein a space into which counterpart terminals are capable of entering is configured by the recess between the first and second side parts of mutually coupled adjacent harness housings.

6. The connector according to claim 1, wherein the holder includes a partition wall extending in the width direction, and each harness housing unit is coupled to both sides of the partition wall.

7. The connector according to claim 6, wherein a locking recess is formed on the partition wall, and a locking protrusion (which is formed in the harness housing possessed by harness housing units on both sides of the partition wall) engages with the locking recess.

8. The connector according to claim 6, wherein the holder includes an end plate part connected to both ends of the partition wall, and a locking member (which includes the locking recess capable of engaging with the locking protrusion of a counterpart connector) is formed on the outer surface of the end plate part.

9. A connector assembly, comprising: the connector according to claim 1; and a counterpart connector comprising a counterpart connector main body including a mating space into which the connector is capable of being inserted.
